(19) United States
(12) Patent Application Publication
(10) Pub. No.: US 2016/0035522 A1
(43) Pub. Date: Feb. 4, 2016

(54) ELECTRIC PART AND SECONDARY BATTERY CIRCUIT AND CIRCUIT BOARD INCLUDING THE SAME

(71) Applicant: KOMATSULITE MFG. CO., LTD., Osaka (JP)

(72) Inventor: Masashi NAMIKAWA, Suita-shi (JP)

(73) Assignee: KOMATSULITE MFG. CO., LTD., Osaka (JP)

(21) Appl. No.: 14/815,441

(22) Filed: Jul. 31, 2015

(30) Foreign Application Priority Data
Aug. 1, 2014 (JP) 2014-157909

(51) Int. Cl. H01H 37/52; H01H 37/04

(52) U.S. Cl. CPC H01H 37/52; H01H 37/043; H01H 2205/002; H01H 2037/046

(57) ABSTRACT

An electric part 100 comprises a terminal piece 102 having an embedded portion 103 embedded in a resinous package 101 and a projecting portion 104 projecting from the package 101 and having a tip end 102e. The projecting portion 104 is provided with a bent section 110 including a first bent position 111 and a second bent position 112. Between the first bent position 111 and the second bent position 112, a diverging position 120 is disposed such that the projecting portion 104 is divided into two or more parts from the diverging position 120 toward the tip end 102e.

### BACKGROUND OF THE INVENTION

1. Technical Field

The present invention relates to an electric part, more particularly to a geometrical structure suitably applicable to a micromini electric part, for example, a micromini circuit breaker built into a secondary battery pack of an electric device and the like.

2. Background Art

In various electric devices, a circuit breaker is employed as a protective means (safety circuit) for a secondary battery, an electric motor or the like of such electric device. The circuit breaker cuts off the electric current in order to protect the secondary battery, the electric motor or the like if an abnormality has occurred, for example, the temperature of the secondary battery has overly increased during discharging or charging, or an overcurrent has flowed in the electric motor incorporated in a machine such as automobile, home electric appliance and the like.

Such circuit breaker used as a protective means is required to operate accurately responding to a temperature change (to have good temperature characteristic) and to show a stable low electric resistance in its conduction state or closed state.

The circuit breaker includes a thermal actuator element for opening or closing the electrical contacts according to the temperature change.

In the international patent application publication No. WO2011/105175 (hereinafter, patent literature 1), a circuit breaker is disclosed, wherein a bimetal is used as the thermal actuator element. The bimetal is, as well known, composed of two layers of metals which has different coefficients of thermal expansion and which are joined together. According to a temperature change, the bimetal changes its shape, and the thermal actuator element using such bimetal can control the opened or closed state of the electrical contacts of the circuit breaker.

Components of the circuit breaker such as the thermal actuator element, a PTC thermistor, a movable-contact piece, and a fixed-contact piece are housed in a package.

In order to use the circuit breaker, a terminal of the fixed-contact piece and a terminal of the movable-contact piece which are projected from the resinous package are connected to an electric circuit of an electric device.

The above-mentioned patent literature 1 discloses that the fixed-contact piece may be integrated with a main body of the package (resinous base) through an insert moulding technique.

(cf. paragraph [0031])

### SUMMARY OF THE INVENTION

### Technical Problem

If the fixed-contact piece is integrated with the main body of the package through an insert moulding technique, a resinous material injected in the mold is liable to leak along the fixed-contact piece, and there is a possibility that mold flashes reaching to the terminal are formed.

In recent years, on the other hand, there is a demand for a production method such that a circuit breaker is surface-mounted on a circuit board, and then the terminals of the circuit breaker are connected to conductive traces or lands of the circuit board through a reflow soldering technique in order to improve the productive efficiency.

If there are mold flashes formed on or near the terminals, their electrical and mechanical connection to the conductive traces or lands is affected.

Further, there is a tendency that the terminals disclosed in the patent literature 1 are difficult to connect surely and firmly without excessively increasing the temperature of the circuit board during reflow soldering because the disclosed terminals are relatively broad and their heat capacity is large.

In order to solve such problems, the present invention was made, and an object of the present invention is to provide an electric part such as circuit breaker, in which good electrical (mechanical) connection to a conductive trace or land of a circuit board can be obtained.

### Solution to Problem

In order to achieve the above-mentioned object, an electric part according to the present invention comprises:

a terminal piece having an embedded portion embedded in a package made of a resinous material, and a projecting portion projecting from an end of the package and having a tip end, wherein

the projecting portion is provided with a bent section including a first bent position on the package side and a second bent position on the tip end side, and

the bent section is provided between the first bent position and the second bent position with a diverging position such that the projecting portion is divided into two or more parts.

In the electric part according to the present invention, it is preferable that the two or more divided parts of the projecting portion are formed by partially removing the material of the projecting portion from the diverging position toward the tip end.

In the electric part according to the present invention, it is preferable that the projecting portion is provided with a first flat area extending between the first bent position and the above-mentioned end of the package.

In the electric part according to the present invention, it is preferable that the projecting portion is provided between the first bent position and the second bent position with a second flat area, and the diverging position is disposed within the second flat area.

In the electric part according to the present invention, it is preferable that the terminal piece is provided with a through-hole at the above-mentioned end of the package so that the resinous material on both sides of the terminal piece is continuous through the through-hole.

The electric part according to the present invention may be constructed as a circuit breaker comprising:

a first terminal piece electrically connected to a fixed contact,

a movable-contact piece with a movable contact for pushing the movable contact onto the fixed contact to make contact therewith,

a second terminal piece electrically connected to the movable-contact piece, and

a thermal actuator element transforming along with its temperature change to move the movable-contact piece so that the movable contact and the fixed contact are opened,

wherein

at least one of the first terminal piece and the second terminal piece is the above-mentioned terminal piece having the embedded portion and the projecting portion.

A circuit board according to the present invention is characterized by including the above-mentioned electric part.

A secondary battery circuit of the present invention is characterized by including the above-mentioned electric part.

### BRIEF DESCRIPTION OF THE DRAWINGS

FIG. 1 is a perspective view of an electric part as an embodiment of the present invention together with a part of a circuit board on which the electric part is surface-mounted.

FIG. 2 is a side view thereof.

FIG. 3 is a perspective view showing terminal pieces of the electric part.

FIGS. 4(a)-4(d) are cross sectional views for explaining processes for moulding a first casing of the electric part.

FIG. 5 is an exploded perspective view of a circuit breaker as a more concrete example of the electric part.

FIGS. 6 and 7 are cross sectional views of the circuit breaker under its closed (normal) state and opened (abnormal) state, respectively.

FIG. 8 is a schematic plan view of a secondary battery pack including the circuit breaker according to the present invention.

FIG. 9 is a diagram of a safety circuit including the circuit breaker according to the present invention.

### DESCRIPTION OF THE PREFERRED EMBODIMENTS

Embodiments of the present invention will now be described in detail in conjunction with accompanying drawings.

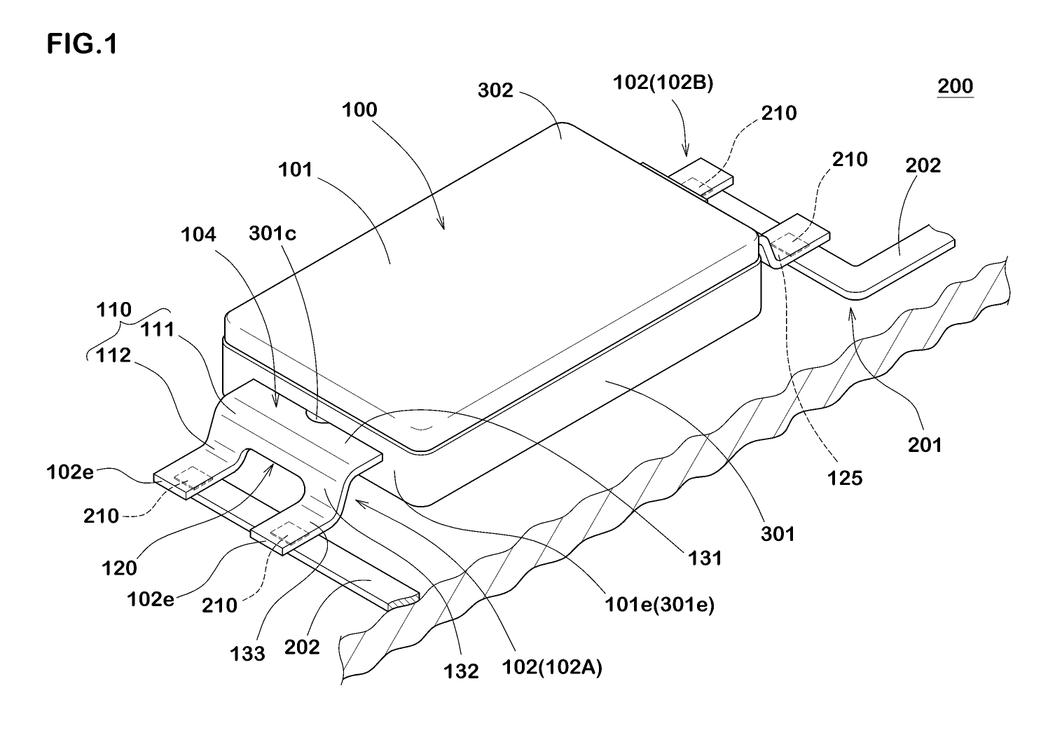

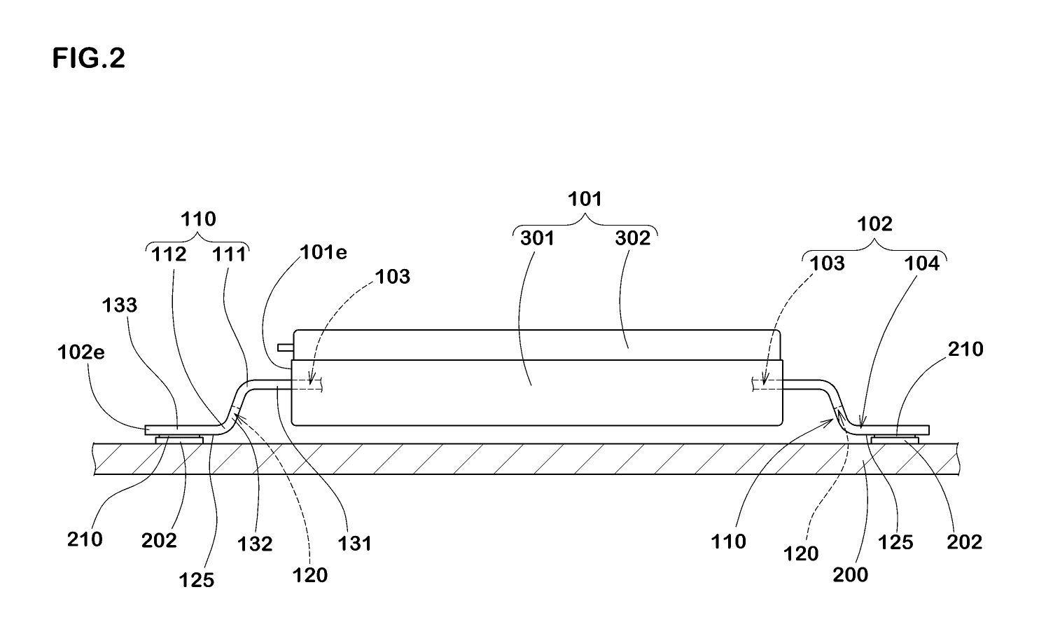

FIG. 1 and FIG. 2 show an electric part 100 as an embodiment of the present invention together with a part of a circuit board 200 on which the electric part 100 is mounted.

The electric part 100 comprises a resinous package 101 which houses components of the electric part 100, and at least one terminal piece 102 to be electrically connected to an external circuit 201 formed on the circuit board 200.

In this embodiment, as shown in FIG. 1, two terminal pieces 102 (102A and 102B) are provided. Obviously, three or more terminal pieces 102 can be provided in this invention.

The resinous package 101 is made of at least one kind of thermoplastic resin, for example, flame-retardant polyamide, heat-resisting polyphenylene sulfide (PPS), liquid crystal polymer (LCP), polybutylene terephthalate (PBT) and the like. Materials other than those above can be used as far as which have moldability, resistance to high temperatures, insulation quality and rigidity similar to those of the above.

The terminal piece 102 is formed by press working from a sheet of metal, for example, copper alloy containing copper in major proportions, copper-titanium alloy, nickel silver, brass and the like.

The terminal piece 102 has an embedded portion 103 embedded in the resinous package 101, and a projecting portion 104 projecting from the resinous package 101.

The embedded portion 103 constitutes an electric circuit connecting the projecting portion 104 to a component inside the resinous package 101.

For example, the embedded portion 103 is embedded through an insert moulding technique for moulding the resinous package 101.

The projecting portion 104 is electrically connected to the external circuit 201 formed on the circuit board 200.

More specifically, the projecting portion 104 is connected to a conductive trace or land (hereinafter, “land”) 202 which is formed on the circuit board 200 to constitute part of the external circuit 201. In order to connect, a soldering technique can be employed, for example.

In order to improve the production efficiency of the circuit board 200 on which the electric part 100 is mounted, a reflow soldering technique is preferably employed to connect the projecting portion 104 to the land 202.

In the reflow soldering technique, the surface of the land 202 is applied by solder 210 in past form, and the electric part 100 is surface mounted on the circuit board 200, then together with the electric part 100, the circuit board 200 is heated to perform soldering.

The projecting portion 104 has a bent section 110, a diverging position 120 from which the projecting portion 104 is divided, and a connector section 125 electrically connected to a land 202.

The bent section 110 includes a first bent position 111 and a second bent position 112.

In the course from the package 101 to the tip end 102e of the projecting portion 104 along the projecting portion 104, as show in FIG. 2, the first bent position 111 and the second bent position 112 are positioned on the package 101 side and the tip end 102e side, respectively, and

the projecting portion 104 is bent toward one side at the first bent position 111 and bent toward the other side at the second bent position 112.

Thus, the bent section 110 is crank-shaped in its side view shown in FIG. 2.

As another example of the bent section 110, it may be possible to bend the projecting portion 104 toward one side at the first bent position 111 and again bent toward the same side at the second bent position 112 so that the bent section 110 is u-shaped in its side view.

In any case, by changing the size or height of the bent section 110 between the first bent position 111 and the second bent position 112, the height of the resinous package 101 from the tip end 102e of the terminal piece 102 can be adjusted, for example, to enable easy proper surface-mounting of the electric part 100 on the circuit board 200.

The diverging position 120 is disposed between the first bent position 111 and the second bent position 112.

From the diverging position 120 toward the tip end 102e (in this embodiment, to the tip end 102e), the projecting portion 104 is divided in its widthwise direction into two or more parts (in this embodiment, two parts).

The above-mentioned connector section 125 connected to the land 202 is formed on the tip end 102e side of the diverging position 120.

In this embodiment, each of the divided parts of the projecting portion 104 is provided with the connector section 125.

As a result, good electrical connection can be obtained between the terminal piece 102 and the land 202 of the external circuit 201.

Preferably, each of the terminal pieces 102 (102A and 102B) is provided with the diverging position 120.

But, it may be possible that at least one of the terminal pieces 102 (in this embodiment, 102A or 102B) is not provided with the diverging position 120, especially if the width of the terminal piece is small.

Since the diverging position 120 is disposed between the first bent position 111 and the second bent position 112, in other words, the diverging position 120 is far from the resinous package 101 than the first bent position 111,

it is possible to prevent possible mold flashes formed on the surface of the projecting portion 104 from reaching to the diverging position 120, and
good electrical connection between the terminal piece 102 and the land 202 can be obtained.

The above-mentioned two or more divided parts of the projecting portion 104 are separated from each other in the widthwise direction by partially removing the metal material of the projecting portion 104.

In this embodiment, as shown in FIG. 1, from the diverging position 120 to the tip end 102e, the metal material of the projecting portion 104 is removed from a central part in the widthwise direction of the projecting portion 104.

Since the metal material is partially removed from the projecting portion 104, the heat capacity of the projecting portion 104 is decreased, and the temperature of the projecting portion 104 becomes easily increased during reflow soldering, therefore, it is possible to complete the soldering in a short time.

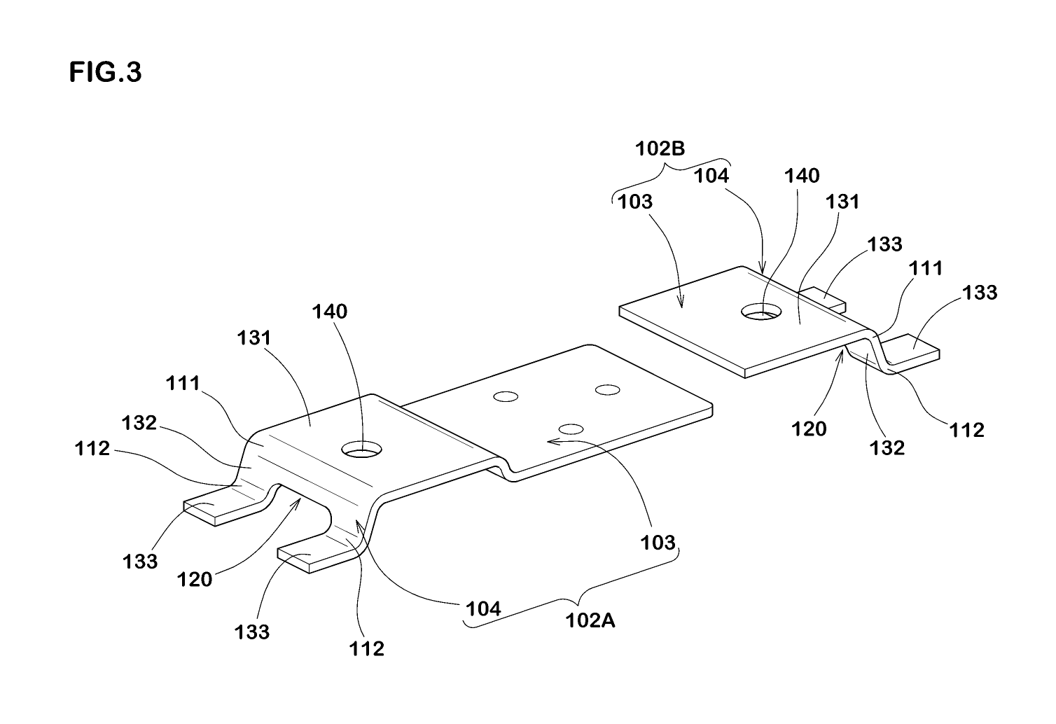

FIG. 3 shows the terminal piece 102A and the terminal piece 102B.

Structure common to both of the terminal pieces 102A and 102B will now be described in detail.

The structure common to the terminal pieces 102A and 102B comprises the embedded portion 103, the projecting portion 104, the first bent position 111, the second bent position 112 and the diverging position 120, and

the common structure can be formed by press working, for example. More specifically, by punching out the terminal piece from the above-mentioned sheet of metal, the embedded portion 103 and the projecting portion 104 are formed, and
the diverging position 120 is provided by forming a through-hole or cutout in the projecting portion 104.

In the case of the above-mentioned U-shaped bent section 110 (not shown), the first bent position 111 and the second bent position 112 are provided through a separate bending process using press dies.

In the case of the stepped (crank-shaped) bent section 110 in this embodiment, the first and second bent positions 111 and 112 can be provided through a separate bending process using press dies, but preferably provided through the above-mentioned press working, simultaneously.

Incidentally, for the smooth handling of the terminal piece 102, the projecting portion 104 may be formed longer than that in the finished product. Such redundant part on the tip end side is cut off before or after the insert moulding of the resinous package 101.

The projecting portion 104 is provided with a first flat area 131 extending between the first bent position 111 and an end 101e of the resinous package 101 from which the projecting portion 104 projects.

In this embodiment, the first flat area 131 extends beyond the end 101e into the embedded portion 103.

The first flat area 131 is provided with a through-hole 140 penetrating through the entire thickness thereof.

It may be possible that the entire through-hole 140 is disposed in the embedded portion 103, namely, at a distance from the end 101e.

But, preferably, the through-hole 140 is disposed in the vicinity of the end 101e of the resinous package 101 so that the through-hole 140 abuts on the end 101e from the embedded portion 103 toward the projecting portion 104, or

the through-hole 140 slightly protrudes from the end 101e toward the projecting portion 104.

In this embodiment, the through-hole 140 slightly protrudes, and a part of the through-hole 140 appears outside the package 101 as shown in FIG. 1.

The shape of the through-hole 140 can be a circle, ellipse, rectangle, etc.

The projecting portion 104 is further provided with a second flat area 132 extending between the first bent position 111 and the second bent position 112.

The above-mentioned diverging position 120 is disposed in the second flat area 132, excluding the first and second bent positions 111 and 112.

Therefore, a second bent position 112 side of the second flat area 132 is divided in the widthwise direction into two or more parts (two parts, in the particular example shown in FIG. 1).

Furthermore, the projecting portion 104 is provided with a third flat area 133 extending from the second bent position 112 to the tip end 102e.

In this embodiment, therefore, the third flat area 133 is divided in the widthwise direction into two or more parts (two parts, in the particular example shown in FIG. 1).

The under surface of the third flat area 133 is electrically connected to the land 202 through solder 210, therefore, the above-mentioned connector section 125 is formed in the under surface of the third flat area 133.

By the provision of the bent section 110 including the first and second bent positions 111 and 112, the first flat area 131 and the third flat area 133 are on different levels or at different heights, as shown in FIG. 2.

Next, the resinous package 101 is described in detail.

In this embodiment, as shown in FIG. 1 and FIG. 2, the resinous package 101 is composed of a first casing 301 and a second casing 302, and

the embedded portion 103 of each terminal piece 102 (102A, 102B) is embedded in the first casing 301.

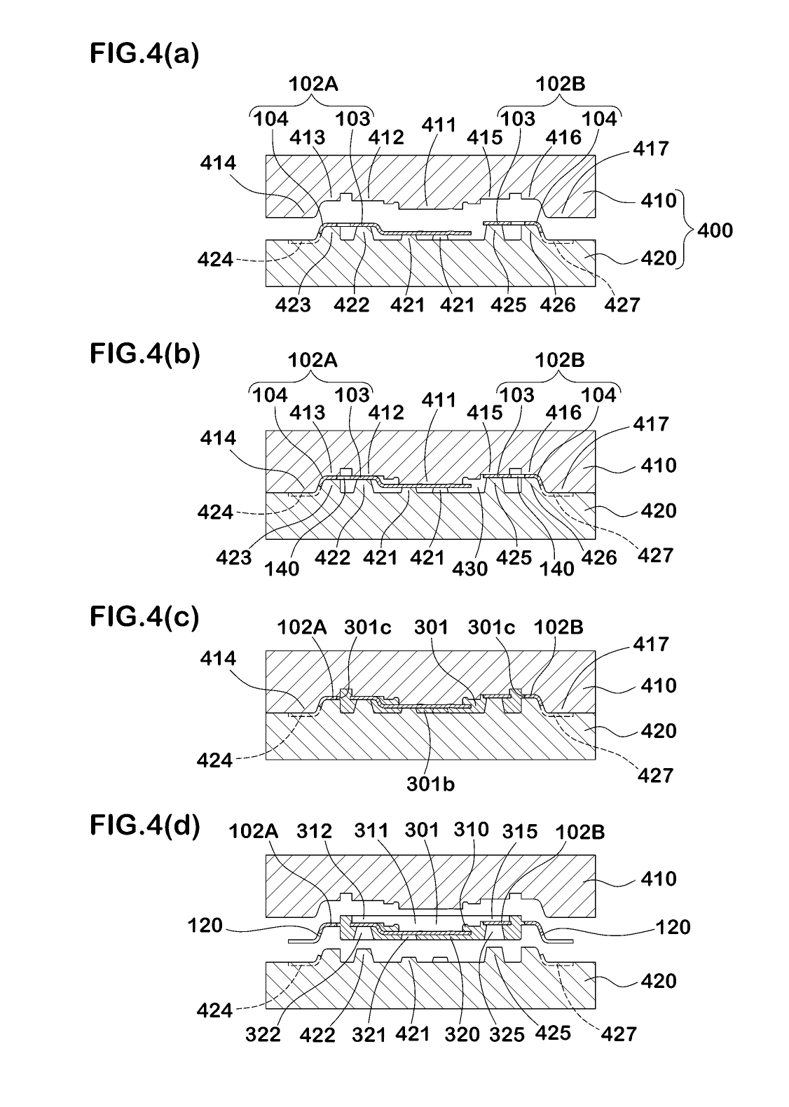

FIGS. 4(a)-4(d) show processes for molding the first casing 301.

The first casing 301 is molded by the use of a mold 400, for example, comprising a male die 410 and a female die 420.

As shown in FIG. 4(b), if the male die 410 and the female die 420 are fitted together and the mold 400 is closed, the mold cavity 430 is formed between the dies.

In this embodiment, each terminal piece 102 (102A, 102B) has the above-mentioned stepped or crank-shaped bent section 110, therefore, by the use of such simple split mold 400, insert moulding of the first casing 301 together with the terminal pieces 102 can be readily performed.

The male die 410 is provided with:

protrusions 411 and 412 coming into contact with the terminal piece 102A inside the mold cavity 430,
protrusions 413 and 414 coming into contact with the terminal piece 102A outside the mold cavity 430,
a protrusion 415 coming into contact with the terminal piece 102B inside the mold cavity 430, and
protrusions 416 and 417 coming into contact with the terminal piece 102B outside mold cavity 430.

The female die 420 is provided with:

protrusions 421 and 422 coming into contact with the terminal piece 102A inside the mold cavity 430,
a protrusion 423 coming into contact with the terminal piece 102A outside mold cavity 430,
a concave portion 424 holding therein the projecting portion 104 of the terminal piece 102A,
a protrusion 425 coming into contact with the terminal piece 102B inside the mold cavity 430,
a protrusion 426 coming into contact with the terminal piece 102B outside mold cavity 430, and
a concave portion 427 holding therein the projecting portion 104 of the terminal piece 102B.

The protrusions are arranged such that, in the closed state of the mold,

the protrusion 421 and the protrusion 411 are opposed to each other so as to hold therebetween the embedded portion 103 of the inserted terminal piece 102A,
the protrusion 422 and the protrusion 412 are opposed to each other so as to hold therebetween the embedded portion 103 of the inserted terminal piece 102A,
the protrusion 423 and the protrusion 413 are opposed to each other so as to hold therebetween the projecting portion 104 of the inserted terminal piece 102A,
the concave portion 424 and the protrusion 414 are opposed to each other so as to hold therebetween the projecting portion 104 of the inserted terminal piece 102A,
the protrusion 425 and the protrusion 415 are opposed to each other so as to hold therebetween the embedded portion 103 of the inserted terminal piece 102B,
the protrusion 426 and the protrusion 416 are opposed to each other so as to hold therebetween the projecting portion 104 of the terminal piece 102B, and
the concave portion 427 and the protrusion 417 are opposed to each other so as to hold therebetween the projecting portion 104 of the terminal piece 102B.

As shown in FIG. 4(a), the terminal piece 102A is mounted on the female die 420 such that the under surface is supported by the protrusions 421, 422 and 423, and

the third flat area 133 is held in the concave portion 424.

Similarly, the terminal piece 102B is mounted on the female die 420 such that the under surface is supported by the protrusions 425 and 426, and

the third flat area 133 is held in the concave portion 427.

When the mold 400 is closed as shown in FIG. 4(b), in the mold cavity 430, the terminal piece 102A is firmly supported from both sides by the protrusions 411 and 421 and the protrusions 412 and 422. Thereby, the terminal piece 102A is positioned at its proper position or posture relative to the mold cavity 430, and the positional precision of the terminal piece 102A relative to the first casing 301 is improved.

Further, on the outside of the mold cavity 430, the terminal piece 102A is firmly supported from both sides by the protrusions 413 and 423 and the protrusions 414 and 424.

Thereby, the occurrence of a gap between the terminal piece 102A and the dies 410 and 420 is prevented, and leakage of the resinous material toward the projecting portion 104 and the resultant mold flush can be prevented.

Similarly, in the mold cavity 430, the terminal piece 102B is firmly supported from both sides by the protrusions 415 and 425. Thereby, the terminal piece 102B is positioned at its proper position or posture relative to the mold cavity 430, and the positional precision of the terminal piece 102B relative to the first casing 301 is improved.

Further, on the outside of the mold cavity 430, the terminal piece 102B is firmly supported from both sides by the protrusions 416 and 426 and the protrusions 417 and 427.

Thereby, the occurrence of a gap between the terminal piece 102B and the dies 410 and 420 is prevented, and leakage of the resinous material toward the projecting portion 104 and the resultant mold flush can be prevented.

Then, as shown in FIG. 4(c), the resinous material 301b for forming the first casing 301 is injected into the mold cavity 430 through a gate (not shown), for example, formed in the female die 420.

The injected resinous material 301b flows into the through-hole 140 of the first flat area 131 to fill it. Therefore, the hardened resinous material 301b on both sides of the first flat area 131, which forms an internal wall and an external wall on the inside and outside of the terminal piece, is connected through the through-hole 140, and the strength and rigidity of the first casing 301 is increased therearound.

Such connection through the through-hole 140 occurs in a region across the end 301e of the first casing 301 in this embodiment. Therefore, even if the projecting portion 104 is subjected to external force to cause torsion or bend for example, the closely contact between the first casing 301 and the embedded portion 103 of the concerned terminal piece 102 can be well maintained.

After the injected resinous material 301b has been hardened in the mold cavity 430, as shown in FIG. 4(d), the mold 400 is opened, and the first casing 301 is removed therefrom.

The molded first casing 301 is provided in the internal wall 310 with opened hollows 311, 312 and 315 formed by the protrusions 411, 412 and 415, respectively.

Further, the molded first casing 301 is provided in the external wall 320 with through-holes 321, 322 and 325 formed by the protrusion 421, 422 and 425, respectively.

When the mold 400 is closed as shown in FIG. 4(b), if a gap occurs between the first flat area 131 of the terminal piece 102A, 102B and the protrusion 423, 426 of the female die 420, then, during injection as shown in FIG. 4(c), the resinous material 301b is leaked into the gap, and mold flash is formed. If the leaked resinous material 301b reaches to the diverging position 120, there is a possibility that the resinous material 301b flows toward the tip end 102e, for example along the edges of the divided parts, and the mold flash is increased in the size.

If the increased mold flash reaches to the under surface of the third flat area 133, namely, the connector section 125, there is a possibility that good electrical connection between the terminal piece 102 and the land 202 is hindered.

In this embodiment, however, since the diverging position 120 is disposed far from the first casing 301 than the first bent position 111, even if the resinous material 301b penetrates into between the first flat area 131 and the protrusion 423, 426, the penetration of the resinous material 301b is prevented from reaching to the diverging position 120. Accordingly, good electrical connection and mechanical connection can be obtained between the terminal piece 102 and the land 202 without hindered by mold flash.

Since the first flat area 131 is disposed between the end 301e of the first casing 301 and the first bent position 111, and the end surfaces of the protrusions 413 and 416 of the male die 410 and the end surfaces of the protrusions 423 and 426 of the female die 420 are formed as flat surfaces,

the sealability between the first flat area 131 and the protrusion 413, 416, 423, 426 is increased, and the occurrence of mold flash can be effectively prevented despite such simple and inexpensive mold structure.

If the diverging position 120 is disposed at the second bent position 112, and the second bent position 112 is formed by the above-mentioned press working on the terminal piece 102 already provided with the diverging position 120 for example by die cutting, then there is a possibility that the curvature of the second bent position 112 becomes uneven in the vicinity of the diverging position 120.

The second bent position 112 having such uneven curvature tends to cause spaces from the dies 410 and 420, inviting the resinous material 301b to penetrate thereinto. This results in mold flash.

Further, there is a possibility that the position or posture of the terminal piece 102 in the mold 400 is affected, and the precision of the electric part 100 is deteriorated.

In this embodiment, however, such drawbacks can be avoided because the diverging position 120 is formed in the second flat area 132, namely, off the second bent position 112, and the curvature of the second bent position 112 can be made uniform over its entire width.

As explained above, the through-hole 140 of the first flat area 131 is filled with the resinous material 301c. Therefore, there is a possibility that the resinous material 301c leaks out from the through-hole 140.

In this embodiment, however, the diverging position 120 is disposed far from the through-hole 140 through the first flat area 131 and the first bent position 111,

therefore, the leaked resinous material 301c is prevented from reaching to the diverging position 120, and the good connection between the terminal piece 102 and the land 202 can be obtained.

If this embodiment is compared with an example where the diverging position 120 is disposed in the first flat area 131 such that the distance from the resinous package 101 to the diverging position 120 is the same as that in this embodiment, the first flat area 131 in this embodiment can be made short, therefore, it is possible to miniaturize the electric part 100.

If this embodiment is compared with an example where the diverging position 120 is disposed in the third flat area 133, the third flat area 133 in this embodiment can be made short, therefore, it is possible to miniaturize the electric part 100.

In this embodiment, it can be said that the mold cavity 430 has a complicated shape since the male die 410 and the female die 420 are provided with the protrusions 411, 412 and 415 and the protrusions 421, 422 and 425.

In order that every hole and corner of the mold cavity 430 is filled with the resinous material 301b, to increase the injection pressure of the resinous material 301b is effectual. In the present invention, even if the injection pressure is increased, the occurrence of the above-mentioned problematic mold flash can be effectively prevented since the diverging position 120 is disposed in the second flat area 132 between the first bent position 111 and the second bent position 112.

While description has been made of an example of the basic structure of the electric part according to the present invention, various changes and modifications may be made into various embodiments of the present invention without departing from the scope of the accompanying claims.

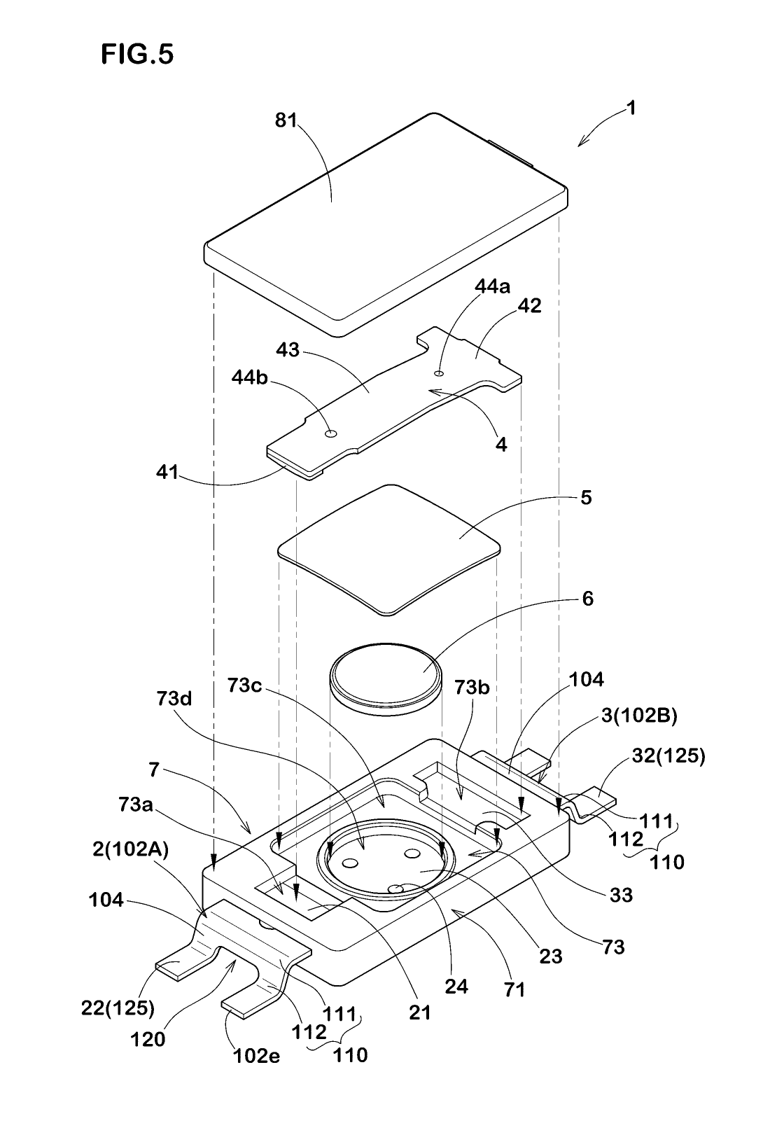

FIG. 5-FIG. 7 show a circuit breaker as an embodiment of the present invention to which the above-described structure of the electric part 100 is applied.

In this application, in order to simplify the description, based on the attitude or orientation of the electric part or circuit breaker shown in the drawings, the terms “up” and “down”, “upper” and “under”, “above” and “below”, etc. are used to describe positional relationships of various parts, portions, positions, directions and the like. But, such description should not be construed as to limit the attitude of the circuit breaker in use. The circuit breaker can be used in every orientation.

The circuit breaker 1 comprises:

a fixed-contact piece 2 with a fixed contact 21,

a terminal piece 3,

a movable-contact piece 4 with a movable contact 41 in its tip end portion,

a thermal actuator element 5 transformable along with its temperature change,

a positive temperature coefficient (PTC) thermistor 6, and

a package 7 housing the fixed-contact piece 2, the terminal piece 3, the movable-contact piece 4, the thermal actuator element 5 and the PTC thermistor 6.

The package 7 is composed of a package's main body 71 and a cover 81 attached to the upper surface of the package's main body 71.

In this embodiment, the shape of the package 7 is substantially a rectangular parallelepiped having a thickness of about 1 mm, a width of about 3 mm and a length of about 5 mm. Also the above-mentioned resinous package 101 of the electric part 100 may have a similar shape and dimensions.

The fixed-contact piece 2 corresponds to the terminal piece 102A shown in FIGS. 1-4. The terminal piece 3 corresponds to the terminal piece 102B shown in FIGS. 1-4. The package 7 corresponds to the resinous package 101 shown in FIGS. 1 and 2. The package's main body 71 corresponds to the first casing 301 shown in FIGS. 1 and 2. The cover 81 is corresponds to the second casing 302 shown in FIGS. 1 and 2.

In the following description of the circuit breaker 1, redundant description may be omitted or reduced. Please refer to the above description of the electric part 100.

The fixed-contact piece 2 is formed from a metal sheet by press working.

For the metal sheet, copper alloys containing copper in major proportions, for example, copper-titanium alloy, nickel silver, brass and the like can be preferably used.

The fixed-contact piece 2 is embedded in the package's main body 71 through an insert moulding technique.

The fixed-contact piece 2 is provided in its outer end portion (outside the package) with a terminal 22 (connector section 125) to be electrically connected to an external circuit. The terminal 22 protrudes outwardly of the package's main body 71 from an end of the package's main body 71.

The fixed-contact piece 2 is further provided in its inner portion (inside the package) with a support section 23 for supporting the PTC thermistor 6.

The support section 23 is provided on the upper surface thereof with three protrusions (dowels) 24.

The support section 23 is exposed through an opened hollow 73d formed in the upper surface of the package's main body 71.

The PTC thermistor 6 is placed on the protrusions (dowels) 24 and supported by the protrusions 24.

The fixed contact 21 is formed by cladding, plating or applying a metal material having superior electrical conductivity, for example, silver, nickel, nickel-silver alloy, copper-silver alloy, gold-silver alloy and the like.

The fixed contact 21 is placed at a position opposed to the movable contact 41, and exposed through an opened hollow 73a formed in the upper surface of the package's main body 71.

The terminal piece 3 is formed from a sheet of metal containing copper in major proportions by press working similarly to the fixed-contact piece 2.

The terminal piece 3 is embedded in the package's main body 71 through an insert moulding technique.

The terminal piece 3 is provided in its one end portion with a terminal 32 (connector sections 125). The terminal 32 protrudes outwardly of the package's main body 71 from an end of the package's main body 71 to be electrically connected to an external circuit.

The terminal piece 3 is further provided in its other end portion (inside the package) with a joint section 33. The joint section 33 is electrically connected to the movable-contact piece 4.

For that purpose, an upper surface of the joint section 33 is exposed through an opened hollow 73b which is formed in the upper surface of the package's main body 71.

Each of the fixed-contact piece 2 and the terminal piece 3 has the above-mentioned embedded portion 103 embedded in the package's main body 71, and the above-mentioned projecting portion 104 projecting from the resinous package 101 and having the bent section 110 and the diverging position 120.

The bent section 110 includes the first bent position 111 on the package 7 side and the second bent position 112.

In this embodiment, the bent section 110 is crank-shaped.

The diverging position 120 is disposed between the first bent position 111 and the second bent position 112.

In this embodiment, each of the fixed-contact piece 2 and the terminal piece 3 is provided with the diverging position 120. But, it may be possible that one of the fixed-contact piece 2 and the terminal piece 3 is provided with the diverging position 120 if suitable.

The fixed-contact piece 2 and terminal piece 3 are each provided with the above-mentioned through-hole 140 (cf. FIG. 3). In this embodiment, the through-hole 140 is arranged to extend from the embedded portion 103 to the projecting portion 104.

Thus, as shown in FIG. 7, the end of the through-hole 140 on the tip end 102e side protrudes from the end 71e of the package's main body 71.

The end of the through-hole 140 on the fixed contact 21 side is positioned within a side wall 71w of the package's main body 71, therefore, leakage of the resinous material toward the fixed contact 21 is prevented, and good conductivity between the fixed contact 21 and the movable contact 41 can be ensured.

The movable-contact piece 4 is formed from a sheet of a metal material by press working in the form of an arm which is symmetric about its center line extending in the longitudinal direction thereof.

As to the metal material of the movable-contact piece 4, a metal containing copper in major proportions which is equivalent to that of the fixed-contact piece 2 is preferably used. In addition, an electrically conductive elastic material, for example, copper-titanium alloy, nickel silver, brass and the like may be used.

The movable-contact piece 4 is provide in its one end portion with a joint section 42 electrically connected to the above-mentioned joint section 33 of the terminal piece 3.

For example, the joint section 42 can be fixed to the joint section 33 by welding.

The movable-contact piece 4 is provided in its other end portion with the movable contact 41.

The movable contact 41 is made of a material equivalent to that of the fixed contact 21 and joined to the under surface of the other end portion of the movable-contact piece 4 by means of welding, cladding, crimping or the like.

Further, the movable-contact piece 4 is provided between the movable contact 41 and the joint section 42 with a resilient section 43.

In the joint section 42, the movable-contact piece 4 is fixed to the joint section 33 of the terminal piece 3.

The resilient section 43 extends from the joint section 42 to the movable contact 41.

In the closed state, the movable contact 41 is pressed onto the fixed contact 21 by elasticity deformation of the resilient section 43.

In the resilient section 43, the movable-contact piece 4 is curved or bent through the press working.

The degree of the curvature or bend may be arbitrarily set by considering the elastic forces at the operating temperature and return temperature, the pressing force for the contact and the like. The degree is not limited as far as the thermal actuator element 5 can be housed together.

The resilient section 43 is provided on the under surface thereof with a pair of protrusions (contact points) 44a and 44b toward the thermal actuator element 5.

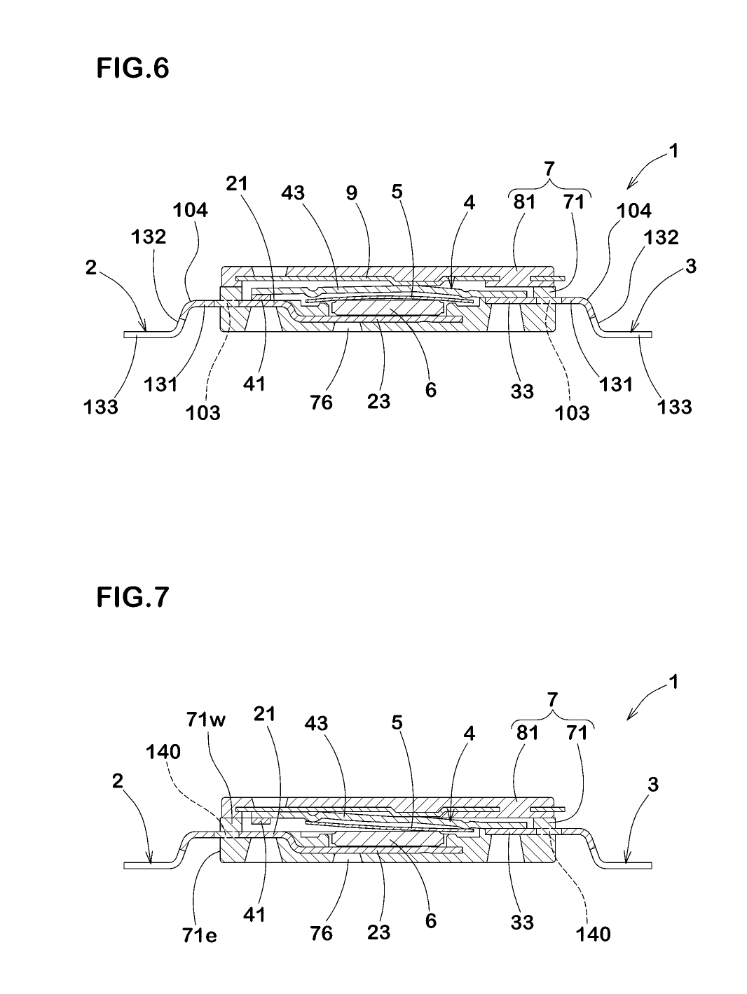

The protrusions 44a and 44b contact with the thermal actuator element 5 in order to introduce the transformation of the thermal actuator element 5 to the resilient section 43 of the movable-contact piece 4. (cf. FIG. 5, FIG. 6 and FIG. 7)

The thermal actuator element 5 is a laminate of thin plates having different coefficients of thermal expansion. The thermal actuator element 5 has an initial shape curved convexly toward one side (upper side, in FIG. 5 and FIG. 6).

If the temperature of the thermal actuator element 5 is increased and reached to the operating temperature, the thermal actuator element 5 is warped in a clap and changes its shape from the above-mentioned initial shape to a shape curved reversely or convexly toward the other side (under side, in FIG. 7).

If the temperature of the thermal actuator element 5 is decreased below the return temperature, the shape reverts to the initial shape in a clap.

It is possible to give such initial shape to the thermal actuator element 5 by press working.

It is preferable that the shape of the thermal actuator element 5 in its plan view is a rectangle from a point of view of the production efficiency and the occurrence of warping. Further, a rectangle close to a square is preferable in order to effectively push up the resilient section 43 while achieving the miniaturization.

However, the shape as well as the material of the thermal actuator element 5 are not to be limited particularly as far as the thermal actuator element 5 warps at the desired temperature to push up the resilient section 43 of the movable-contact piece 4, and the shape reverts to the initial shape by the elastic force of the resilient section 43.

As to the materials of the thermal actuator element 5, two kinds of materials having different coefficients of thermal expansion are selected from various alloys to meet the required conditions, for example:

copper-nickel-manganese alloy or nickel-chrome-iron alloy for the higher coefficient of thermal expansion, and
iron-nickel alloy, nickel silver, brass or stainless steel for the lower coefficient of thermal expansion.

The PTC thermistor 6 is disposed between the fixed-contact piece 2 and the thermal actuator element 5.

If the thermal actuator element 5 is warped as explained above, the fixed contact 21 and the movable contact 41 are opened.

If opened during the electric current flows between the contacts 21 and 41, an electric current flowing in the PTC thermistor 6 increases from substantially zero.

The type, material, shape and the like of the PTC thermistor 6 can be arbitrary selected according to the required conditions, the operating current, operating voltage, operating temperature, return temperature and the like.

This embodiment uses a PTC thermistor made from a ceramic sintered compact comprising barium titanate, strontium titanate or calcium titanate. Aside from such ceramic sintered compact, an polymeric PTC comprising a polymer matrix loaded with carbon black particles or the like may be used.

The package's main body 71 and the cover 81 constituting the package 7 are each made of a thermoplastic resin, e.g. flame-retardant polyamide, heat-resisting polyphenylene sulfide (PPS), liquid crystal polymer (LCP), polybutylene terephthalate (PBT) and the like. Of course, materials other than those above can be used as far as which have moldability, resistance to high temperatures, insulation quality and rigidity similar to those of the above.

The package's main body 71 is provided with a holding recess 73 for holding therein the movable-contact piece 4, the thermal actuator element 5 and the PTC thermistor 6.

The holding recess 73 includes:

the above-mentioned opened hollow 73a and opened hollow 73b for holding therein the movable-contact piece 4;

the above-mentioned opened hollow 73d for holding therein the PTC thermistor 6; and

an opened hollow 73c for holding therein the movable-contact piece 4 and the thermal actuator element 5.

The shape and size of the holding recess 73 is such that the inner surface of the holding recess 73 comes into contact with the edges of the movable-contact piece 4, the thermal actuator element 5 and the PTC thermistor 6 which are built in the package's main body 71 so as to guide the edges of the moving parts when the thermal actuator element 5 is warped.

The cover 81 is provided with a metallic cover piece 9 embedded therein through an insert moulding technique.

The cover piece 9 is formed by press working of a sheet of a metal, for example, the above-mentioned metal containing copper in major proportions, stainless steel and the like.

On the upper surface of the metallic cover piece 9, the above-mentioned resin is disposed to form an outer surface of the cover 81.

On the other hand, as shown in FIG. 6 and FIG. 7, the most part of the under surface of the metallic cover piece 9 is exposed, and timely comes into contact with the movable-contact piece 4 to limit the movement of the movable-contact piece 4.

Further, the metallic cover piece 9 increases the rigidity and strength of the cover 81 and the package 7 and helps to miniaturize the circuit breaker 1.

The cover 81 is, as shown in FIG. 5, assembled with the package's main body 71 so as to close the opened hollows 73a, 73b, 73c and 73d of the package's main body 71 in which the movable-contact piece 4, the thermal actuator element 5, the PTC thermistor 6 and the like are held.

For example, through an ultrasonic welding technique, the cover 81 is joined to the package's main body 71.

As shown in FIG. 6, in the normal operating state of the circuit breaker 1 under normal temperature, the thermal actuator element 5 keeps the initial shape, and

the fixed contact 21 and the movable contact 41 are closed. Thereby, the circuit breaker 1 is normally conductive between the terminals 22 and 32 through the resilient section 43 of the movable-contact piece 4, etc.

In the normal operating state, as shown in FIG. 6, the resilient section 43 may contact with the thermal actuator element 5. If contact, an electrical path through the movable-contact piece 4, the thermal actuator element 5, the PTC thermistor 6 and the fixed-contact piece 2 is formed.

Even so, since the electric resistance of the PTC thermistor 6 is very high when compared with the electric resistance of the movable-contact piece 4, the electric current flowing in the PTC thermistor 6 is negligibly small in comparison with the electric current flowing between the fixed contact 21 and the movable contact 41.

In the abnormal operating state of the circuit breaker 1 when the thermal actuator element 5 is subjected to high temperature and the temperature reaches to the operating temperature, as shown in FIG. 7,

the thermal actuator element 5 is warped and pushes up the resilient section 43 of the movable-contact piece 4 to open the movable contact 41 and the fixed contact 21.

Therefore, the electric current flowing between the fixed contact 21 and the movable contact 41 is shut off, but a small leak current flows through the thermal actuator element 5 and the PTC thermistor 6.

As far as the leak current flows, the PTC thermistor 6 generates heat so that the warped state of the thermal actuator element 5 is maintained. Thereby, a self-holding circuit where only the small leak current flows bypassing between the fixed contact 21 and the movable contact 41 is constituted.

Incidentally, such leak current may be utilized for another function of the safety system.

If the voltage between the terminals 22 and 32 is removed or reduced to stop the heat generation from the PTC thermistor 6 and the temperature of the thermal actuator element 5 is decreased to the return temperature, then the thermal actuator element 5 reverts to the initial shape, and

the movable contact 41 and the fixed contact 21 are closed by the elastic force of the resilient section 43 of the movable-contact piece 4. Thus, the circuit breaker 1 returns to the conduction state shown in FIG. 6.

In the circuit breaker 1 having the structure as described above, each of the fixed-contact piece 2 and the terminal piece 3 has the projecting portion 104 projecting from the package's main body 71, and the projecting portion 104 has the bent section 110 and the diverging position 120.

By changing the size of the bent section 110, the height of the package's main body 71 from the tip end 102e of the terminal piece 102 (namely, fixed-contact piece 2 and terminal piece 3) can be adjusted to facilitate the mounting of the circuit breaker 1 onto the circuit board 200 (cf. FIG. 1).

Since the diverging position 120 is disposed between the first bent position 111 and the second bent position 112 of the bent section 110, possible mold flash along the projecting portion 104 is prevented from reaching to the diverging position 120, and accordingly, good electrical connection and mechanical connection can be obtained between the fixed-contact piece 2 and the land 202 and between the terminal piece 3 and the land 202 without hindered by the mold flash.

While description has been made of one preferable embodiment of the circuit breaker according to the present invention, various changes and modifications may be made in the present invention without departing from the scope of the accompanying claims, for example, as follows.

After the package 7 is assembled, the circuit breaker 1 can be hermetically-sealed with resin or the like, for example by inserting the package 7 in a mold and injecting the resin or the like, so that the terminal 22 of the fixed-contact piece 2 and the terminal 32 of the terminal piece 3 are exposed outside the resultant hermetic seal coating.

The method for joining the cover 81 and the package's main body 71 is not limited to the ultrasonic welding.

But, as far as they are firmly joined, another method, for example, a liquid or gelled adhesive agent can be employed.

The package 7 may have a structure made up of three or more parts aside from the structure made up of two parts, the package's main body 71 and the cover 81.

Further, the shapes of the fixed-contact piece 2, the terminal piece 3, the movable-contact piece 4, the thermal actuator element 5, the PTC thermistor 6, the holding recess 73 and the like can be changed arbitrarily without limited to those shown in the drawings.

Instead of using two separate pieces: the movable-contact piece 4 and the terminal piece 3, it may be possible to use a single piece in which the movable-contact piece 4 and the terminal piece 3 are integrated. In this case, such single piece is sandwiched between the package's main body 71 and the cover 81 which are welded to each other and thereby welded to the single piece.

Further, instead of using two separate pieces: the movable-contact piece 4 and the thermal actuator element 5, it may be possible to use a single piece in which the movable-contact piece 4 and the thermal actuator element 5 are integrated by forming the movable-contact piece 4 from a laminate of thin metal plates such as bimetal and trimetal in order to simplify the structure of the circuit breaker and thereby further miniaturize the circuit breaker.

The above-mentioned embodiment of the circuit breaker includes the self-holding circuit utilizing the PTC thermistor 6. But, the present invention can be applied to a circuit breaker not provided with a PTC thermistor constituting a self-holding circuit. In this case, it may be possible to further miniaturize the circuit breaker.

In the above-mentioned embodiment of the circuit breaker, the fixed contact 21 is formed on the fixed-contact piece 2 corresponds to a terminal piece 102, and the movable contact 41 is formed on the movable-contact piece 4 connected to the terminal piece 3 corresponds to another terminal piece 102.

But, the present invention can be applied to such a circuit breaker comprising: two fixed contacts formed on two terminal pieces 102, respectively, and a thermal actuator element formed from bimetal or trimetal and provided with two movable contacts, both of which make contact with the two fixed contacts, respectively, in its normal conductive state, and at least one of which is spaced apart from the corresponding fixed contact in its abnormal nonconductive state.

The circuit breaker 1 according to the present invention can be widely applied to a secondary battery pack, a safety circuit for electric devices and the like.

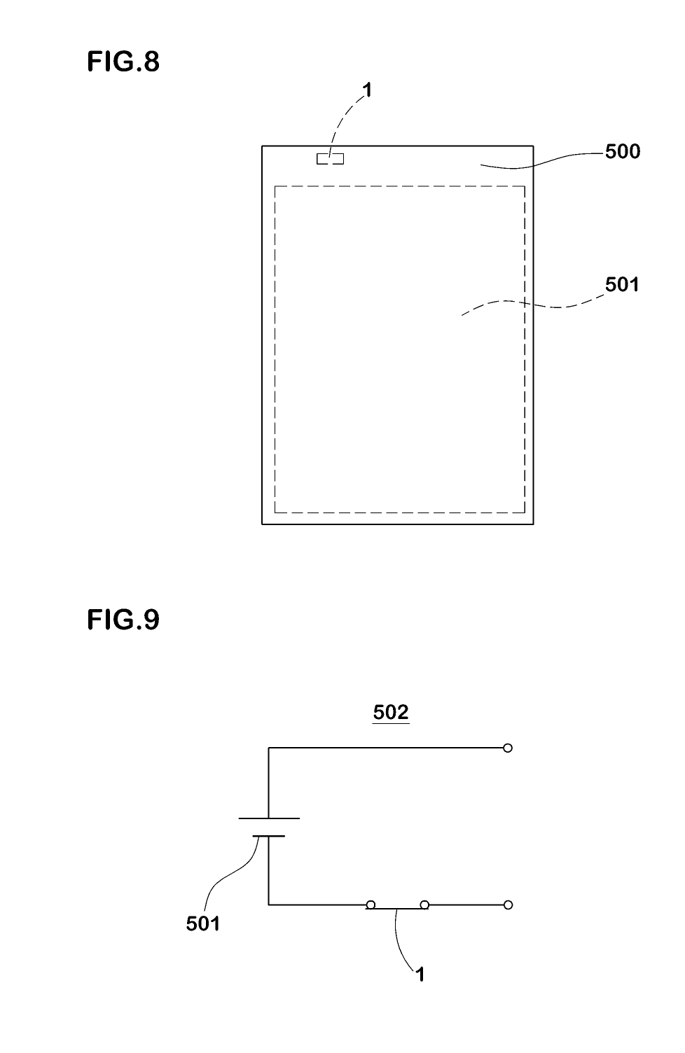

FIG. 8 shows a secondary battery pack 500 which comprises a secondary battery 501 and the circuit breaker 1 inserted in an output circuit of the secondary battery 501.

FIG. 9 shows a safety circuit 502 for electric devices, comprising the circuit breaker 1 inserted in series in an output circuit of a secondary battery 501. For example, the safety circuit 502 is formed on the circuit board 200.

By incorporating the circuit breaker 1, it is possible to provide the secondary battery pack 500 or safety circuit 502 in which good current cutoff action is assured.

Aside from the circuit breaker, the present invention can be applied to various electric parts comprising a resinous package, and at least one terminal piece having an embedded portion in the resinous package and a projecting portion from the resinous package.

### REFERENCE SIGNS LIST

1 circuit breaker
2 fixed-contact piece
21 fixed contact
3 terminal piece
4 movable-contact piece
41 movable contact
5 thermal actuator element
7 package
71 package's main body
81 cover
100 electric part
101 resinous package
102 terminal piece
103 embedded portion
104 projecting portion
110 bent section
111 first bent position
112 second bent position
120 diverging position
131 first flat area
132 second flat area
140 through-hole
200 circuit board
501 secondary battery

1. An electric part comprising:
a terminal piece having an embedded portion embedded in a package made of a resinous material, and a projecting portion projecting from an end of the package and having a tip end, wherein
the projecting portion is provided with a bent section including a first bent position on the package side and a second bent position on the tip end side, and
the bent section is provided between the first bent position and the second bent position with a diverging position such that the projecting portion is divided into two or more parts.

2. The electric part according to claim 1, wherein the two or more divided parts of the projecting portion are formed by partially removing the material of the projecting portion from the diverging position toward the tip end.

3. The electric part according to claim 1, wherein the projecting portion is provided with a first flat area extending between the first bent position and said end of the package.

4. The electric part according to claim 3, wherein the projecting portion is provided between the first bent position and the second bent position with a second flat area, and
the diverging position is disposed within the second flat area.

5. The electric part according to claim 1, wherein the terminal piece is provided with a through-hole at said end of the package so that the resinous material on both sides of the terminal piece is continuous through the through-hole.

6. The electric part according to claim 2, wherein the terminal piece is provided with a through-hole at said end of the package so that the resinous material on both sides of the terminal piece is continuous through the through-hole.

7. The electric part according to claim 3, wherein the terminal piece is provided with a through-hole at said end of the package so that the resinous material on both sides of the terminal piece is continuous through the through-hole.

8. The electric part according to claim 4, wherein the terminal piece is provided with a through-hole at said end of the package so that the resinous material on both sides of the terminal piece is continuous through the through-hole.

9. The electric part according to claim 1, which is a circuit breaker comprising:
a first terminal piece electrically connected to a fixed contact,
a movable-contact piece with a movable contact for pushing the movable contact onto the fixed contact to make contact therewith,
a second terminal piece electrically connected to the movable-contact piece, and
a thermal actuator element transforming along with its temperature change to move the movable-contact piece so that the movable contact and the fixed contact are opened, wherein
at least one of the first terminal piece and the second terminal piece is said terminal piece having the embedded portion and the projecting portion.

10. A circuit board comprising the electric part according to claim 1.

11. A secondary battery circuit including the electric part according to claim 9.
